(19) United States
(12) Patent Application Publication
(10) Pub. No.: US 2002/0100558 A1
(43) Pub. Date: Aug. 1, 2002

(54) Inner lead bonding apparatus

(75) Inventor: Koji Sato, Akishima-shi (JP)

Correspondence Address: KODA & ANDROLIA, 2029 Century Park East, Suite 3850, Los Angeles, CA, 90067-3024, US

(73) Assignee: KABUSHIKI KAISHA SHINKAWA

(21) Appl. No.: 10/062,235

(22) Filed: Feb. 1, 2002

(30) Foreign Application Priority Data
Feb. 1, 2001 (JP) 2001-25514

(51) Int. Cl. B29C 65/00

(52) U.S. Cl. 156/363; 156/285

(57) ABSTRACT

An inner lead bonding apparatus including a bonding stage that holds a semiconductor chip by vacuum suction and moves the semiconductor chip to beneath a workpiece, a bonding head that is disposed on one side of work guides for guiding the workpiece and is driven horizontally, a bonding tool that is disposed on the bonding head so as to be above the workpiece and vertically movable, a recognition camera provided on the bonding head so as to be offset at a position that is separated from the bonding tool, and a tool cleaning section disposed on another side of the work guides; and an effective cleaning surface of the tool cleaning section is provided so as to be located beneath the bonding tool when the recognition camera has moved to the bonding position.

### BACKGROUND OF THE INVENTION

1. Field of the Invention

The present invention relates to an inner lead bonding apparatus which bonds semiconductor chips to leads of a workpiece such as a lead frame, film, board, etc., and more particularly to such an inner lead bonding apparatus that is equipped with a tool cleaning section for cleaning the bonding tool.

2. Prior Art

Japanese Patent Application Laid-Open (Kokai) No. H7-201931 discloses a conventional inner lead bonding apparatus that is equipped with a tool cleaning section.

In this prior art bonding apparatus, a semiconductor chip is bonded to the upper surface of a workpiece; and a bonding head which holds and conveys the semiconductor chips by vacuum suction is disposed above the workpiece, and a recognition camera and bonding tool are disposed beneath the workpiece. The recognition camera and bonding tool are fastened to a moving table so as to be positioned on both sides of the workpiece. The tool cleaning section is disposed at an intermediate point on the movement path of the bonding tool that is moved during the bonding operation. In other words, work guides that guide the workpiece and the tool cleaning section provided between the recognition camera and the bonding tool.

In this prior art bonding apparatus, the bonding tool passes beneath the tool cleaning section. Accordingly, debris adhering to the bonding tool cleaning section as a result of cleaning falls and contaminates the surface of the bonding tool and the surface of the moving table. Furthermore, in this bonding apparatus, the recognition camera and bonding tool are disposed on the moving table on both sides of the work guides and tool cleaning section. Accordingly, the bonding tool is in a position that is greatly separated from the bonding position during recognition of the alignment of the workpiece and the semiconductor chip by the recognition camera (i.e., when the recognition camera is positioned in the bonding position). As a result, the distance over which the bonding tool is moved to the bonding position after alignment recognition by the recognition camera is long, and loss time is generated in the bonding operation, resulting in poor productivity.

### SUMMARY OF THE INVENTION

Accordingly, the object of the present invention is to provide an inner lead bonding apparatus that can avoid contamination to the bonding tool, etc. and reduce loss time in the bonding operation, thus improving the productivity.

The above object is accomplished by a unique structure for an inner lead bonding apparatus of the present invention that comprises:

a bonding stage which holds a semiconductor chip by vacuum suction and moves the semiconductor chip to beneath a workpiece,

a bonding head which is disposed on one side of work guides for guiding the workpiece and is driven horizontally,

a bonding tool disposed above the workpiece, the bonding tool being provided on the bonding head so as to be moved vertically,

a recognition camera provided on the bonding head, the recognition camera being offset to a position that is separated from the bonding tool, and

a tool cleaning section disposed on another side of the work guides, wherein

an effective cleaning surface of the tool cleaning section is provided so as to be beneath the bonding tool when the recognition camera has moved to the bonding position.

The above object is further accomplished by another unique structure for an inner lead bonding apparatus of the present invention that comprises:

a bonding stage which holds a semiconductor chip by vacuum suction and moves the semiconductor chip to beneath a workpiece,

a bonding head which is disposed on one side of work guides for guiding the workpiece and is driven horizontally,

a bonding tool disposed above the workpiece, the bonding tool being provided on the bonding head so as to be moved vertically,

a recognition camera provided on the bonding head, the recognition camera being offset to a position that is separated from the bonding tool, and

a tool cleaning section disposed beneath the bonding tool when the recognition camera has moved to the bonding position, the tool cleaning section being disposed:

on another side of the work guides which is on an imaginary line extending from the bonding position parallel to an imaginary line connecting the recognition camera with the bonding tool, or

on another side of the work guides which is on an extension of an imaginary line connecting the recognition camera with the bonding tool.

In the above unique structures, the tool cleaning section is comprised of a grindstone and a brush which is installed adjacent to the grindstone and faces the work guide.

### BRIEF DESCRIPTION OF THE DRAWINGS

FIGS. 1A, 1B and 1C are respectively top, front and side views of one embodiment of the inner lead bonding apparatus according to the present invention;

FIGS. 2A and 2B are respectively top and side views of the state in which the bonding tool is positioned above the bonding position;

FIG. 3 is a top view of the relationship between the recognition camera and the bonding tool and between the bonding position and the tool cleaning sections when the recognition camera is not positioned directly above the bonding position.

### DETAILED DESCRIPTION OF THE INVENTION

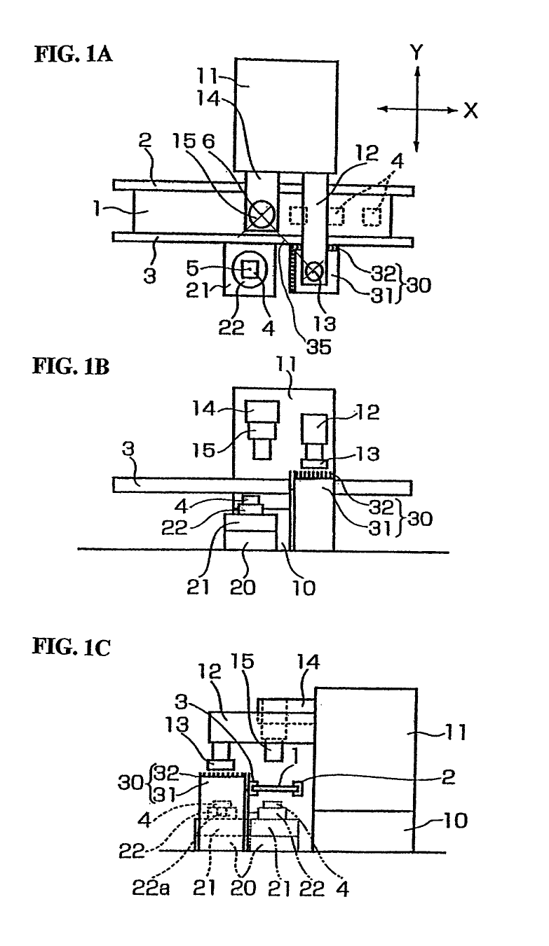

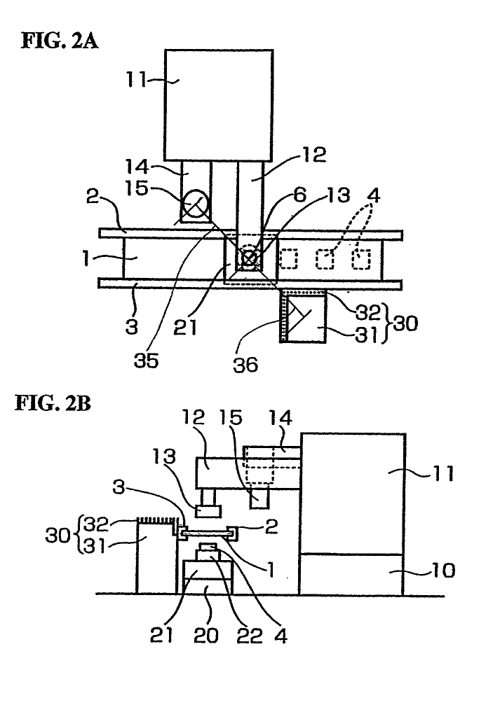

One embodiment of the present invention will be described with reference to FIGS. 1A through 1C and FIGS. 2A and 2B.

A workpiece 1 on which leads (not shown) are disposed at regular intervals is guided by work guides 2 and 3 and intermittently conveyed by a driving means (not shown). First XY table 10 which is driven in the directions of the X and Y axes or horizontally is disposed on the side of or next to the work guide 2, and a bonding head 11 is mounted on this first XY table 10.

A bonding arm 12 which is driven by a driving means (not shown) is installed on the bonding head 11 so as to be moved upward and downward, and a bonding tool 13 is fastened to the tip end portion of the bonding arm 12 so as to face the upper surface of the workpiece 1.

Furthermore, a camera arm 14 is fastened to the bonding head 11, and a recognition camera 15 is disposed on the camera arm 14. The recognition camera 15 is offset to a position that is separated from the bonding tool 13.

Second XY table 20 which is driven in the directions of the X and Y axes or horizontally is disposed on the side of or next to the work guide 3, and a rotating table 21 is mounted on this second XY table 20. A bonding stage 22 is provided on the rotating table 21, and a vacuum suction chucking hole 22a which holds a semiconductor chip 4 on the bonding stage 22 by vacuum suction chucking is formed in the bonding stage 22. Accordingly, the bonding stage 22 is arranged so as to be moved between a chip alignment position 5 and a point beneath the workpiece 1 in the bonding position 6 as best seen from FIG. 1C.

A tool cleaning section 30 which is used to clean the bonding tool 13 is disposed on the side of or next to the work guide 3. The tool cleaning section 30 is comprised of a grindstone 31 and a brush 32. The brush 32 is disposed adjacent to this grindstone 31 and on the work guide side so as to face the work guide 3. The effective cleaning surface of the grindstone 31 of the tool cleaning section 30 is provided so as to be beneath the bonding tool 13 when the recognition camera 15 has moved to the bonding position 6.

As seen from the above, the bonding head 11 is provided on one side of the work guides 2 and 3, and the tool cleaning section 30 is provided on another side of the work guides 2 and 3

The operation of the above embodiment will be described below.

Before the bonding operation is initiated, the recognition camera 15 is positioned directly above the bonding position 6 as shown in FIGS. 1A through 1C. Accordingly, the bonding tool 13 is positioned above the effective cleaning surface of the grindstone 31 of the tool cleaning section 30. Also, the bonding stage 22 is positioned in the chip alignment position 5 in which the bonding stage 22 is retracted from the position directly beneath the bonding position 6.

Then, when a semiconductor chip on a wafer or in a tray (not shown) is picked up by a pickup device (not shown) and conveyed onto the bonding stage 22 which is positioned in the chip alignment position 5, vacuum suction is applied from the vacuum suction chucking hole 22a of the bonding stage 22. As a result, the semiconductor chip 4 is held on the bonding stage 22 by vacuum suction.

When the workpiece 1 is intermittently driven by the driving means (not shown) so that the leads of the workpiece 1 are conveyed to the bonding position 6, the bonding stage 22 is moved in the directions of the X and Y axes by the second XY table 20, and the semiconductor chip 4 that is held on the bonding stage 22 by vacuum suction is conveyed to a point beneath the bonding position 6 as indicated by the two-dot chain line in FIG. 1C.

Then, the positional deviation between the leads of the workpiece 1 and the semiconductor chip 4 is detected by the recognition camera 15, and this positional deviation is corrected by way of the movement of the bonding stage 22 in the directions of the X and Y axes by the second XY table 20 and by way of the rotation of the bonding stage 22 in the direction of the θ axis by the rotating table 21. During this period, the bonding tool 13 is lowered and pressed against the tool cleaning section 30.

Next, the bonding tool 13 is moved to a point above the bonding position 6 as shown in FIGS. 2A and 2B. Before this movement of the bonding tool 13 to the bonding position 6, the bonding tool 13 is lowered. Thus, when the lowered bonding tool 13 is moved to the bonding position 6, the bonding tool 13 is cleaned by the grindstone 31 of the tool cleaning section 30, and the contaminants that adhere to the bonding tool 13 are wiped away by the brush 32.

Then, the bonding stage 22 is raised so that the semiconductor chip 4 is pressed against lead of the workpiece 1. At the same time, the bonding tool 13 is lowered at the bonding position 6 so that the lead of the workpiece 1 is pressed downward, and the semiconductor chip 4 is bonded.

Afterward, the bonding tool 13 is moved upward and advances so as to return to the original starting position shown in FIGS. 1A through 1C. More specifically, the recognition camera 15 is positioned directly above the bonding position 6, and the bonding tool 13 is positioned above the effective cleaning surface of the grindstone 31 of the tool cleaning section 30.

One cycle of chip bonding is thus completed. Subsequently, the semiconductor chip 4 is successively bonded to the leads of the workpiece 1 by repeating the above-described operation.

Thus, cleaning of the bonding tool 13 is performed by pressing the bonding tool 13 against the upper surface of the tool cleaning section 30. Thus, the debris, etc. adhering to the tool cleaning section 30 does not fall, and there is no contamination to the bonding tool 13, etc. Furthermore, the bonding tool 13 is located on the effective cleaning surface of the grind stone 31 of the tool cleaning section 30 when the recognition camera 15 is positioned above the bonding position 6, and the subsequent movement of the bonding tool 13 for the purpose of bonding is performed over a short distance from the tool cleaning section 30 to the bonding position 6. Thus, the loss time in the bonding operation is reduced, and productivity can be improved.

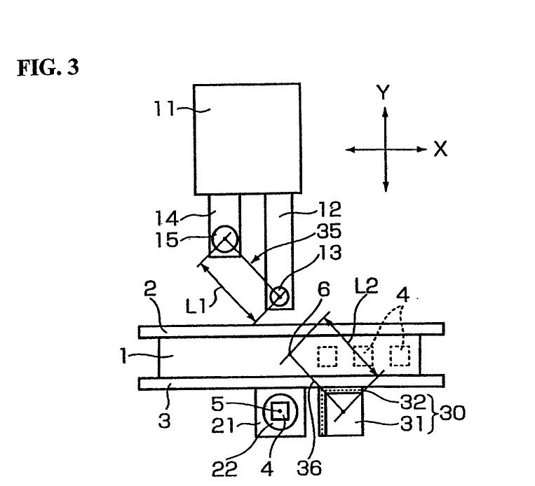

Prior to the initiation of the bonding operation, the recognition camera 15 is positioned directly above the bonding position 6 as shown in FIGS. 1A through 1C. However, when the recognition camera 15 is in a position in which the camera 15 has been retracted from the position directly above the bonding position 6 as shown in FIG. 3, the recognition camera 15 and bonding tool 13, and the bonding position 6 and tool cleaning section 30, are in the following relationship:

The present invention is structured so that when the recognition camera 15 is moved to the bonding position 6, as seen from FIG. 1A, the effective cleaning surface of the grindstone 31 of the tool cleaning section 30 is located on the imaginary line 35 that connects the recognition camera 15 with the bonding tool 13 and beneath the bonding tool 13. Accordingly, the tool cleaning section 30 is on an imaginary line 36 that extends from the bonding position 6 so as to be parallel to an imaginary line 35 that connects the recognition camera 15 with the bonding tool 13, and also the tool cleaning section 30 is beneath the bonding tool 13 at the time that the recognition camera 15 has moved to the bonding position 6. In other words, the imaginary lines 35 and 36 are parallel, and the distance L1 between the recognition camera 15 and the bonding tool 13 and the distance L2 between the bonding position 6 and the tool cleaning section 30 are equal.

Furthermore, when the bonding tool 13 is moved to above the bonding position 6, as seen from FIG. 2A, the effective cleaning surface of the grindstone 31 of the tool cleaning section 30 is on an extension line 36 of the imaginary line 35.

As seen from the above, the inner lead bonding apparatus of the present invention is comprised of: a bonding stage that holds a semiconductor chip by vacuum suction and moves the semiconductor chip to beneath a workpiece, a bonding head that is disposed on one side of work guides for guiding the workpiece and is driven horizontally, a bonding tool that is disposed on the bonding head so as to be above the workpiece and vertically movable, a recognition camera provided on the bonding head so as to be offset at a position that is separated from the bonding tool, and a tool cleaning section disposed on another side of the work guides; and an effective cleaning surface of the tool cleaning section is provided so as to be beneath the bonding tool when the recognition camera has moved to the bonding position. Accordingly, the bonding tool, etc. is avoided from being contaminated, the loss time in the bonding operation is reduced, and productivity is improved.

1. An inner lead bonding apparatus comprising:
a bonding stage which holds a semiconductor chip by vacuum suction and moves said semiconductor chip to beneath a workpiece,
a bonding head disposed on one side of work guides that guide said workpiece, said bonding head being driven in a horizontal direction,
a bonding tool disposed above said workpiece, said bonding tool being provided on said bonding head so as to be moved upward and downward,
a recognition camera provided on said bonding head, said recognition camera being offset to a position that is separated from said bonding tool, and
a tool cleaning section disposed on another side of said work guides, wherein
an effective cleaning surface of said tool cleaning section is located beneath said bonding tool when said recognition camera is moved to said bonding position.

2. An inner lead bonding apparatus comprising:
a bonding stage which holds a semiconductor chip by vacuum suction and moves said semiconductor chip to beneath a workpiece,
a bonding head disposed on one side of work guides that guide said workpiece, said bonding head being driven in a horizontal direction,
a bonding tool disposed above said workpiece, said bonding tool being provided on said bonding head so as to be moved upward and downward,
a recognition camera provided on said bonding head, said recognition camera being offset to a position that is separated from said bonding tool, and
a tool cleaning section disposed beneath said bonding tool when said recognition camera is moved to said bonding position, said tool cleaning section being positioned:
on another side of said work guides which is on an imaginary line extending from said bonding position parallel to an imaginary line connecting said recognition camera with said bonding tool, or
on another side of said work guides which is on an extension of an imaginary line connecting said recognition camera with said bonding tool.

3. The inner lead bonding apparatus according to claim 1, wherein said tool cleaning section comprises a grind stone and a brush which is installed adjacent to said grind stone and faces said work guides.

4. The inner lead bonding apparatus according to claim 2, wherein said tool cleaning section comprises a grind stone and a brush which is installed adjacent to said grind stone and faces said work guides.
